(19) United States
(12) Patent Application Publication
(10) Pub. No.: US 2011/0050597 A1
(43) Pub. Date: Mar. 3, 2011

(54) TOUCH SCREEN DEVICE

(76) Inventors: Dong Sun PARK, Seoul (KR); Yeon Ho Son, Gyunggi-do (KR); Jae Kyung Kim, Gyunggi-do (KR)

(21) Appl. No.: 12/582,148

(22) Filed: Oct. 20, 2009

(30) Foreign Application Priority Data
Aug. 28, 2009 (KR) 10-2009-0080610

(51) Int. Cl. G06F 3/041

(52) U.S. Cl. 345/173

(57) ABSTRACT

Disclosed herein is a touch screen device. The touch screen device includes a touch screen panel, an image display, an injection molded support member, a support frame, a vibration unit and a vibration transmission medium. The touch screen panel receives a touch signal from a user. The image display is provided under the touch screen panel to display images. The image display comprises a plurality of layers. An injection molded support member is attached at one side thereof to the periphery of the lower surface of the image display. The support frame covers the image display and the injection molded support member. The vibration unit is mounted under the support frame to generate vibrations. The vibration transmission medium is interposed between the image display and the support frame to transmit the vibrations from the support frame to the image display.

### CROSS REFERENCE TO RELATED APPLICATION

This application claims the benefit of Korean Patent Application No. 10-2009-0080610, filed Aug. 28, 2009, entitled “Touch screen device”, which is hereby incorporated by reference in its entirety into this application.

### BACKGROUND OF THE INVENTION

1. Technical Field

The present invention relates to a touch screen device.

2. Description of the Related Art

Recently, according to requirements of consumers to enhance the convenience of using electronic products, there are an increasing number of electronic products using touch screens which allow a signal to be input in a manner wherein the presence and location of touching within a display area is detected. Touch screen devices not only include the concept of inputting a signal by touching but also include the concept of incorporating the intuitive experience of a user into an interface and of diversifying feedback.

Touch screen devices have many advantages because the size of a device can be reduced, it can be easily and simply manipulated, the specifications thereof can be easily changed, a user can easily recognize information, and it is compatible with other IT devices. Because of these advantages, touch screen devices are widely used in various fields including industry, traffic, services, medical care, mobile products, etc.

Typically, in touch screen devices, a transparent touch panel is disposed close to an image display, such as an LCD, which displays an image. A user observes the image through the touch panel and presses a desired portion of the touch panel, at which time a vibration unit applies vibration to the touch panel, thus transmitting a sensation of vibration to the user.

In a representative touch screen device according to a conventional technique, an image display is attached to a lower surface of a touch screen panel. An injection-molded support member supports the periphery of the image display, and a support frame supports the lower surface of the image display.

A vibration unit is mounted under the support frame. The vibration unit vibrates depending on whether or not it was touched.

However, a space is necessarily left between the image display and the support frame. Thus, there is a problem in that the efficiency of transmitting vibrations from the vibration unit to the image display is reduced.

Therefore, research into a technique capable of maximizing the efficiency of transmitting vibrations from the vibration unit to the image display is required.

### SUMMARY OF THE INVENTION

The present invention has been made in an effort to provide a touch screen device which is constructed such that the efficiency of transmitting vibrations from a vibration unit to a touch screen panel can be maximized.

In a touch screen device according to an embodiment of the present invention, a touch screen panel receives a touch signal from a user. An image display is provided under the touch screen panel to display images. The image display comprises a plurality of layers. An injection molded support member is attached at one side thereof to the periphery of the lower surface of the image display. A support frame covers the image display and the injection molded support member. A vibration unit is mounted under the support frame to generate vibrations. A vibration transmission medium is interposed between the image display and the support frame to transmit the vibrations from the support frame to the image display.

The touch screen panel may be integrated with the image display.

The vibration unit may comprise a piezoelectric or polymer actuator or motor.

The vibration transmission medium may comprise an adhesive.

In addition, the vibration transmission medium may comprise tape.

The vibration transmission medium may comprise a filling substance capable of transmitting the vibrations.

Furthermore, a frequency of the vibration unit may be changeable.

The vibration unit may comprise one single layer or a plurality of layers.

In the touch screen device according to the present invention, a vibration transmission medium is interposed between an image display and a support frame. Thus, the efficiency of transmitting vibrations from a vibration unit mounted under the support frame to the image display and the touch screen panel can be maximized.

Furthermore, because the efficiency of transmission of vibrations is increased, the vibration unit can be manufactured to be smaller in size. In particular, in the case of a piezoelectric actuator which is expensive, the effect of reducing the production cost can be markedly increased.

In addition, the sensation when the user touches the touch screen panel can be varied depending on the frequency of the vibration unit. Hence, the marketability of the touch screen device can be enhanced.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view illustrating a touch screen device, according to an embodiment of the present invention;

FIG. 2 is a sectional view illustrating the touch screen device according to the embodiment of the present invention; and

FIG. 3 is a view showing the state of the touch screen device when touched by a user's finger according to the embodiment of the present invention.

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, a preferred embodiment of the present invention will be described in detail with reference to the attached drawings.

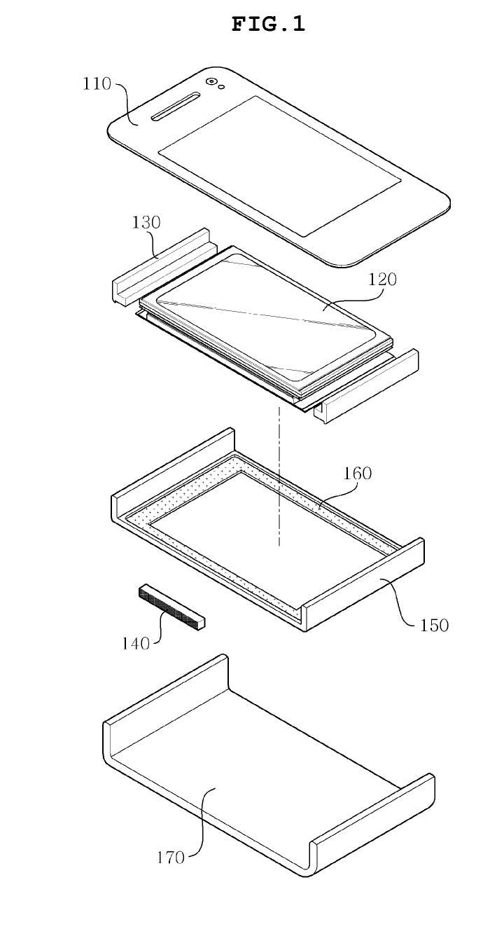

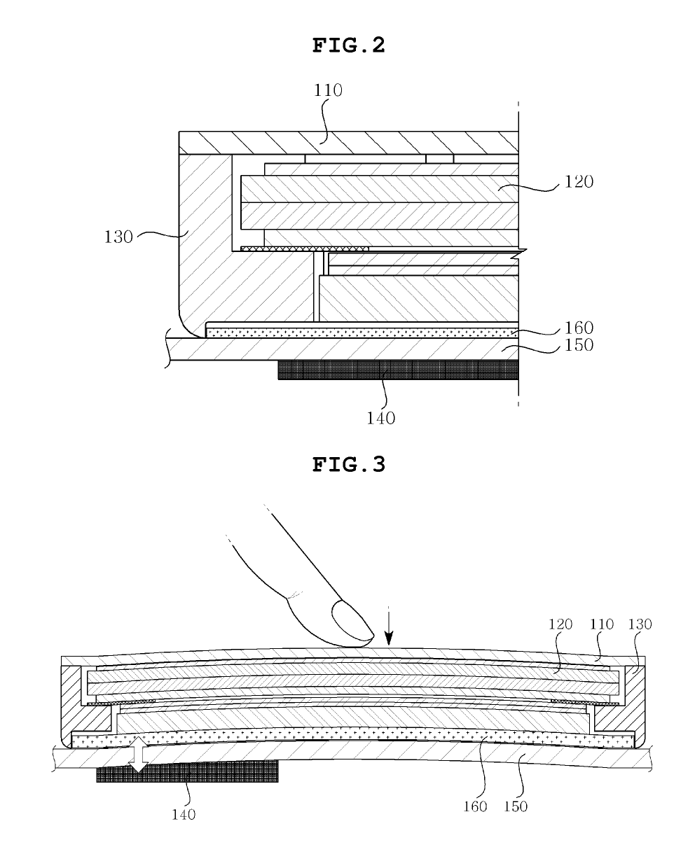

FIGS. 1 and 3 illustrate a touch screen device 100 according to the embodiment of the present invention. The touch screen device 100 includes a touch screen panel 110, an image display 120, injection molded support members 130, a vibration unit 140, a support frame 150, a vibration transmission medium 160 and a lower casing 170.

The touch screen panel 110 is transparent and flexible and functions as a signal input surface which enables a user to observe an image displayed on the image display 120 and press it to input a signal. For instance, the touch screen panel 110 has a rectangular shape which extends a predetermined length in the longitudinal direction of the touch screen device 100.

The touch screen panel 110 is made, for example, by laminating an outer film, an ITO (indium tin oxide) film and a base film.

In detail, the outer film is disposed on a front surface of a mobile communication terminal and is sectioned into a viewing area within which touch input is available, and a dead space area which is formed around the viewing area. The outer film is made of transparent film material, such as PET (poly ethylene terephthalate), to allow the user to observe the image display 120 through the outer film.

The ITO film is formed by laminating two upper and lower film layers, although it is not in detail shown in the drawings. A dot spacer is interposed between the upper and lower film layers of the ITO film to maintain the distance therebetween constant. An electrode membrane having an X-axis pattern and a Y-axis pattern is provided on the perimeter of each film layer. The X-axis pattern and the Y-axis pattern are electrically separated from each other by an insulator (not shown). The electrode membrane is exposed outside the ITO film through an FPC (flexible printed circuit) cable and is electrically connected to the mobile communication terminal.

The base film supports the entire touch panel. For example, a glass substrate having superior transmissivity and a high touch response speed can be used as the base film.

The image display 120 converts a variety of electrical information provided by various units into visual information using the variation of transmittance of a liquid crystal which depends on applied voltage. The image display 120 is mounted under the touch screen panel 110 and comprises one or more layers.

In the touch screen device 100 of the present invention, the image display 120 may be integrally coupled to the lower surface of the touch screen panel 110. A user observes an image expressed on the image display 120 and touches a desired portion of the touch screen panel 110 to input the information he/she desires to input. Then, an image to corresponding to the input information is displayed on the image display 120. The above-mentioned structure is advantageous in that the productivity and the ability to withstand impacts are increased, compared to those of the conventional structure in which the touch screen panel 110 and the image display 120 are provided separately from each other.

The injection molded support members 130 function as a vibration transmission plate which transmits vibrations generated from the vibration unit 140 to the touch screen panel 110. Each injection molded support member 130 is attached at one surface thereof to the perimeter of the lower surface of the image display 120 and has a stepped structure on the lower portion thereof.

The support frame 150 is mounted under the image display 120 and the injection molded support members 130. The support frame 150 has a stepped structure which can cover the image display 120 and the injection molded support members 130 to protect them from external impact.

In the structure in which the support frame 150 covers the lower portions of the injection molded support member 130 and the image display 120, a space is necessarily left between the image display 120 and the support frame 150, though it is very small. This space disturbs the transmission of vibrations. To eliminate such a space in a structural manner is the gist of the present invention.

The vibration transmission medium 160 which is provided to eliminate a space left between the image display 120 and the support frame 150 in a structural manner will be described in detail later.

As such, the support frame 150 supports and covers the lower portions of the image display 120 and the injection molded support members 130 to protect them from external impact.

The vibration unit 140 which vibrates as a result of voltage being applied thereto from a power supply is mounted under the support frame 150.

The vibration unit 140 functions to generate vibrations and apply them to the touch screen panel 110. The vibration unit 140 comprises a piezoelectric (or polymer) actuator or motor which can be formed thin and generate vibrations in such a way that it is expanded and contracted by external power in the longitudinal direction.

The vibration unit 140 may have a single layer structure or, alternatively, may have a structure formed by laminating several layers.

The lower casing 170 is mounted to the lower surface of the support frame 150 to which the vibration unit 140 is mounted. The lower casing 170 covers the lower portions of the image display 120, the injection molded support members 130 and the vibration unit 140.

Meanwhile, in the conventional technique, when the vibration unit 140 which is mounted under the support frame 150 generates vibrations, the vibrations may not be reliably transmitted to the image display 120 because of a space that is left between the image display 120 and the support frame 150.

In the present invention, to overcome the above-mentioned conventional problem, the vibration transmission medium 160 is provided between the image display 120 and the support frame 150, thus eliminating the space which has been left between the support frame 150 and the image display 120. Thereby, vibrations generated from the vibration unit 140 can be optimally transmitted to the image display 120 and the touch screen panel 110.

Here, the vibration transmission medium 160 may comprise one of various kinds of adhesives, such as a UV adhesive, a thermosetting adhesive, etc. Furthermore, the vibration transmission medium 160 may be fluid or solid. In the case where the vibration transmission medium 160 comprises one of various kinds of adhesives, it is applied to the upper surface of the support frame 150 and thus fills the space between the support frame 150 and the image display 120.

Then, when the vibration unit 140 mounted under the support frame 150 vibrates, vibrational force of the vibration unit 140 can be directly transmitted to the image display 120 through the vibration transmission medium 160 which is applied to the support frame 150.

Alternatively, the vibration transmission medium 160 may comprise one of various kinds of tape. The tape can be made of any material other than non woven fabric and may be provided with adhesive applied to the surface thereof or have no adhesive.

In this case, vibrations generated from the vibration unit 140 mounted under the support frame 150 can be directly transmitted to the image display 120 through the vibration transmission medium 160 which is charged into the space between the support frame 150 and the image display 120.

As a further alternative, the vibration transmission medium 160 may comprise a filling substance, such as an injection-molded substance. The material or shape of the filling substance is not limited to a special material or shape, but must satisfactorily transmit vibrations. The filling substance is mounted to the upper surface of the support frame 150.

In this case, vibrations generated from the vibration unit 140 mounted under the support frame 150 can also be directly transmitted to the image display 120 through the vibration transmission medium 160 which is charged into the space between the support frame 150 and the image display 120, thus maximizing a vibration transmission rate between the vibration unit 140 and the image display 120.

As shown in FIG. 3, when the user touches the upper surface of the touch screen panel 110, the vibration unit 140 vibrates. The vibrations are transmitted to the image display 120 and the touch screen panel 110 through the vibration transmission medium 160.

Here, the sensation when the user touches the touch screen panel 110 can be varied depending on the frequency of the vibration unit 140.

As described above, in the touch screen device 100 according to the present invention, the vibration transmission medium 160 which comprises adhesive, tape or a filling substance is interposed between the image display 120 and the support frame 150. Thus, the efficiency of transmitting vibrations from the vibration unit 140 mounted under the support frame 150 to the image display 120 and the touch screen panel 110 can be maximized.

Therefore, because the efficiency of transmission of vibrations is increased, the vibration unit can be manufactured to be smaller in size. In particular, in the case of a piezoelectric actuator which is expensive, the effect of reducing the production cost can be markedly increased.

Although the embodiment of the present invention has been disclosed for illustrative purposes, it will be appreciated that a touch screen device according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen device, comprising:
a touch screen panel receiving a touch signal from a user;
an image display provided under the touch screen panel to display images, the image display comprising a plurality of layers;
an injection molded support member attached at one side thereof to a periphery of a lower surface of the image display;
a support frame covering the image display and the injection molded support member;
a vibration unit mounted under the support frame to generate vibrations; and
a vibration transmission medium interposed between the image display and the support frame to transmit the vibrations from the support frame to the image display.

2. The touch screen device as set forth in claim 1, wherein the touch screen panel is integrated with the image display.

3. The touch screen device as set forth in claim 1, wherein the vibration unit comprises a piezoelectric or polymer actuator or motor.

4. The touch screen device as set forth in claim 1, wherein the vibration transmission medium comprises an adhesive.

5. The touch screen device as set forth in claim 1, wherein the vibration transmission medium comprises tape.

6. The touch screen device as set forth in claim 1, wherein the vibration transmission medium comprises a filling substance capable of transmitting the vibrations.

7. The touch screen device as set forth in claim 1, wherein a frequency of the vibration unit is changeable.

8. The touch screen device as set forth in claim 1, wherein the vibration unit comprises one single layer or a plurality of layers.
